(19) United States
(12) Patent Application Publication
(10) Pub. No.: US 2009/0079557 A1
(43) Pub. Date: Mar. 26, 2009

(54) Warning system for signaling to vehicle operator that a child has been left Unattended In An Infant Seat

(76) Inventor: Steven Miner, Horizon City, TX (US)

Correspondence Address: The Weintraub Group;32000 Northwestern Highway, Suite 240, Farmington Hills, MI, 48334, US

(21) Appl. No.: 11/918,924

(22) PCT Filed: Apr. 19, 2006
(86) PCT No.: PCT/US2006/014593

§ 371 Date: Oct. 19, 2007

(51) Int. Cl. B60Q 1/00

(52) U.S. Cl. 340/457.1

(57) ABSTRACT

A wireless, self-activating, proximity warning system utilizes an on-board computer of an automobile and a GPS locating system to sending a warning signal to a vehicle operator that a child has been left buckled and unattended in an infant seat. A transmitter associated with the child seat transmits coded RF signals of certain strength to a receiver carried by the operator. The receiver triggers an alarm when the signal strength or time between transmitted signals indicates that the operator has gone beyond a permitted range.

### CROSS-REFERENCE TO RELATED APPLICATIONS

This Application claims benefit and priority of co-pending U.S. Provisional Patent Application Ser. No. 60/672,789, filed Apr. 19, 2005, the disclosure of which is hereby incorporated by reference in its entirety.

### BACKGROUND OF THE INVENTION

1. Field of the Invention

The present invention pertains to a warning system for sending a warning signal to a vehicle operator that a child has been left buckled and/or unattended in an infant seat, and more particularly, to a wireless, self-activating, proximity warning system that transmits RF, sonic, or similar signals, including GPS and the like signals of certain strength from the child seat to a plurality of possible receivers, one receiver in particular carried by the operator and triggers an alarm when signal strength or time between different types of signals or a separation distance determined by a GPS system indicates that the operator has gone beyond a permitted range, and another receiver in particular installed in an automobile, although not limited to an automobile, produces an output capable of being used by automobile manufacturers to design warning systems to alert that a child has been left unbuckled and/or unattended in an infant seat.

2. Background Art

Current motor vehicle laws typically require that a child under a certain age be buckled into an infant seat, and that the infant seat be secured on the back seat of the motor vehicle. As such, the child is out of the sight of the vehicle operator, and possibly due to the rush of a busy day, also out of mind. When the vehicle operator leaves the car, a distraction or other diversion may cause the operator to forget that the child is still in the car, or the operator, believing that they will leave the vehicle for a short period of time may just leave the child in the vehicle.

Dangers associated with leaving children in a parked vehicle are well documented. In particular, the temperature inside a parked vehicle in the sun rapidly increases to frighteningly high levels. These elevated heat levels frequently exceed levels that are considered to be dangerous to human beings. Accordingly, a warning system for alerting the vehicle operator that the child has been left unattended would be desirable.

Modern day vehicles typically have a belt sensor that is used to detect whether the seat belt buckle is buckled or unbuckled, or a weight sensor in the vehicle seat to detect an occupied seat status. However, the typical use of child restraint systems or car seats renders these obvious methods of detection useless, because when a child seat is typically installed the seat belt is semi-permanently buckled and the installation causes constant downward pressure on the seat, which causes weight sensors to constantly indicate an occupied status.

Many designs are complex and would interfere with the removal and or moving and collapsing of many of the seats in use in vehicles today.

Oftentimes, the sensing of the buckled or unbuckled state is performed after the ignition is started and an indicator associated with the sensor is used to remind the vehicle operator to fasten the seat belt.

Additionally, vehicles typically only have a driver seat belt sensor and, at most, a front seat passenger seat belt; the rear seats may not have a seat belt sensor at all. The child restraint seat is typically secured to the back seat of the vehicle, such as by the vehicle seat belt. Typically, the restraint belts of the infant seat are not interconnected to any vehicle sensor.

A seat belt system, operatively associated with the vehicle ignition, is helpful in situations wherein the vehicle operator is with the child in the car, but not when the vehicle operator is some distance away from the vehicle. A warning system that is operable with the seat belt system of any infant seat would be desirable.

The use of alerting devices for sensing and warning of the presence of an occupant in a vehicle are disclosed in U.S. Pat. Nos. 5,705,990 to Messier; 5,793,291 to Thornton; 6,028,509 to Rice; 6,104,293 to Rossi; 6,489,889 to Smith; 6,489,889 to Smith; 6,535,137 to Ryan; and 6,642,838 to Barnas. For example, a warning signal may be initiated to signal one or more of the following: the vehicle door is open, a certain temperature has been reached inside the vehicle, motion within the vehicle, or the state of the vehicle ignition system (e.g., the ignition is off. The warning signal may also be in the form of the horn, lights, or the illumination of an indicator light on the dash board of the vehicle alerting devices and systems.

Again, a disadvantage of many of these prior devices is that once the vehicle operator leaves and walks away from the vehicle, an alert is not initiated. However, a child may be left fastened and unattended in the restraint seat.

A further disadvantage of these prior devices is that some are complex, or installed in the vehicle as original equipment and not portable, or limited to providing the operator with an in-situ alarm, or not adaptable for use with different infant car seats. Additionally, the modern infant seat may be placed in an older car, which is not equipped with electronic features found in current vehicles.

A further disadvantage of many of these prior devices is that they may locate equipment in the leaky diaper zone and require cleaning and sterilization after leaky diaper accidents.

Additionally a further disadvantage of many of these prior devices is that some may require a very complex installation that is not easily removed and replaced for cleaning purposes.

A further disadvantage of many of these devices is that the design might have a limited range of responses available to an alert status. For example, many of the devices would not be able to utilize the advanced features found in modern vehicles such as making automatic phone calls in emergencies, alerting authorities with GPS locations, automatically starting vehicles with climate controls, etc.

A further disadvantage to many of these prior devices is that they might be rendered useless by a catastrophic failure of the vehicles electrical system or computer system.

A further disadvantage to many designs is that they are complex and would interfere with the removal and or moving and collapsing of many of the seats in use in vehicles today.

Desirably, an alarm system that can be incorporated into the restraint of any infant seat, and used in any vehicle in which the infant seat is emplaced, would be a significant advance in obviating situations wherein the infant is inadvertently left in the vehicle.

Desirably, the operator would be provided with a child alert signaling apparatus wherein after the vehicle operator has walked a predetermined distance from the vehicle, the operator is provided with an alarm, signaling that a child has been inadvertently left in the vehicle.

In this regard, the apparatus would desirably be capable of self checking by the operator to know at the time of leaving the vehicle that the system is operating and that the power sources in both the transmitter and receiver are sufficient and not too low.

Desirably, the owner would be provided with a method of adapting and standardizing car seats to work with alarms that are built into the vehicle, and transmit a signal that a child has been inadvertently left in the vehicle.

Further, such an alarm system could overcome the foregoing disadvantages.

### SUMMARY OF THE INVENTION

A primary object of this invention is the provision of a warning system for signaling the presence of a child in an infant seat, the system being portable, at least in part, and generating and transmitting an alarm to the vehicle operator as a result of the operator having walked away from the vehicle and the infant remaining latched in the infant seat.

00014B Another primary object of this invention is the provision of a wireless apparatus for signaling the presence of a child in a child seat, and generating and transmitting an acceptable signal to various vehicle on board computers or on board alarm systems or on board alarm circuits as may be beneficial in alerting and reminding the vehicle's occupants and operator that there is a child present in an infant seat, thereby aiding in the prevention of leaving the child unattended in the vehicle.

Another object of this invention is the provision of wireless apparatus, including a transmitter associated with an infant latched into an infant seat and a receiver carried by the vehicle operator, which receiver measures the strength of a signal from the transmitter and generates an alarm signal to the operator when the signal strength falls below a prescribed level, thereby indicating that a child has been left unattended in the vehicle.

Another object of this invention is the provision of a wireless warning system which generates an alarm signal based on the distance between a receiver and transmitter and the strength of a signal transmitted there between, wherein the distance before the alarm signal is generated can be increased or decreased, as desired.

Another object of this invention is the provision of an alarm system for use in an infant restraint seat, which system is simple, inexpensive, and capable of being provided as original equipment with currently manufactured vehicles or retrofitted on older cars.

Another object of this invention is the provision of an alarm system, which can be removed and reassembled on an infant seat to permit cleaning of the seat.

These and other objects and advantages of the invention may be attained with a warning system for warning a vehicle operator of the presence of a child buckled into an infant seat of the vehicle, the warning system comprising:

an RF transmitter, said transmitter being connected to a chest clip of said infant seat and adapted to generate and transmit an RF signal of predetermined strength and frequency when the chest clip of the infant seat is buckled, and

a portable RF receiver unit, said receiver unit including an alarm device and adapted to receive said RF signal,

said alarm device being operable to activate an alarm signal when the RF receiver exceeds a predetermined distance from the RF transmitter.

In an aspect of this embodiment, the RF receiver unit includes an electrical circuit in operable relation with said alarm device, said electrical circuit including:

means for comparing the strength of the RF signal received from the transmitter with a reference value representative of the strength of said RF signal when said receiver unit is at said predetermined distance and generating an output when the receiver unit is at said predetermined distance, and

means for connecting the output to the alarm device, wherein to activate said alarm signal.

According to an embodiment of this invention there is provided apparatus for warning a vehicle operator having left the vehicle that a child has been left buckled in a car seat of the vehicle, the apparatus comprising:

means for detecting that a child is buckled into a car seat,

transmitting means for transmitting an RF signal of predetermined frequency when said the chest clip of the child seat is buckled, said transmitting means, connected to said detector means,

portable receiving means for receiving an RF signal of predetermined strength, the receiving means being operably connected to an alarm device having an alarm signal, the receiving means activating the alarm signal to alert said vehicle operator when the strength of said RF signal falls below a permitted value.

According to an aspect of this embodiment of the invention, said transmitting means is operably associated with the chest clip of the car seat and is activated upon interengagement of the seat belt buckle about the child.

According to another aspect of this embodiment of the invention, the permitted value is adjustable and representative of a permitted proximity that said receiving means may be from said transmitting means.

According to another aspect of this embodiment of the invention,

said transmitting means further includes means for transmitting an off signal to said receiving means when said chest clip is unbuckled, and

said receiving means includes a receiver adapted to receive said off signal and turn off the alarm signal.

According to the above embodiments of the invention, said transmitting means and said receiving means each include separate power sources and each, respectively, are adapted to transmit and receive RF signals that are coded.

According to another embodiment of this invention, there is provided an alarm apparatus for indicating the presence of a child buckled in a child restraint seat and left unattended in a vehicle when the vehicle operator is remote to the vehicle, the alarm apparatus comprising:

a proximity transmitter capable of transmitting an RF signal of predetermined frequency and strength, said transmitter being coupled to the seat belt and activated upon buckling of the seat belt,

a proximity receiver capable of receiving RF signals transmitted from said transmitter,

a proximity range adjuster coupled to said receiver for comparing the time taken for the RF signal from the RF transmitter to be received by the RF receiver with a predetermined range and generating an alarm signal when the time taken is not within the predetermined range, the time taken being representative of a maximum predetermined distance that the vehicle operator is permitted to be from the infant seat.

In an aspect of this latter embodiment, the predetermined range can be increased or decreased, depending upon whether the vehicle operator wishes to increase or decrease the distance the vehicle operator is permitted to be from the vehicle before an alarm signal is generated.

According to yet another aspect of this invention, there is provided a method of warning a vehicle operator remote to the vehicle that a child has been left buckled and unattended in a vehicle, the steps of the method comprising:

fastening the child into the child restraint of a car seat in the vehicle, said child restraint including seat belt structure that is fitted about the child and releasable interlockable chest clip buckles that are buckled together, said chest clip structure being provided with a radio frequency (“RF”) transmitter that is activated when the chest clip buckles are interlocked and adapted to generate and transmit a signal of predetermined strength and frequency when the restraint is closed, and

providing the vehicle operator with a portable RF receiver equipped with an alarm device, said RF receiver including electrical circuitry for receiving the signal of predetermined frequency, measuring and comparing the strength of the signal received with a reference strength that is representative of a permissive distance between the receiver and the transmitter, and transmitting an alarm signal to the alarm device when the compared signal strength and reference value deviate from a permissible are not substantially the same as the reference value,

wherein when said child restraint is closed about the child and the vehicle operator provided with the receiver is remote to the vehicle by a distance greater than that permitted by the reference value, the alarm signal is transmitted to the alarm device and the vehicle operator is warned.

Advantageously, the wireless RF system described herein is simple and easy to use. Further by the transmitter being integrated with the chest clip system of the car seat, the transmitter is hidden from abuse and/or inadvertent use by the child. Additionally, the wireless RF system may advantageously be powered by separately replaceable batteries or, at least in part, by wiring extending through the fastening system of the restraint wherein to be in electrical circuit relation with the battery of the vehicle.

The receiver may be conveniently carried on the key ring of the vehicle operator, and even be integrated into the wireless “fob” used by the vehicle operator to gain access to the vehicle.

Further, the child alert system is such that visual or audio confirmation is provided by circuitry in the transmitter and receiver whereby to permit the operator to self check the system prior to leaving the vehicle and be assured that the system is working and that the battery in the receiver, or transmitter, is sufficient and not low.

Further, the wireless RF system described herein advantageously enables the vehicle operator to adjust the distance at which the alarm signal is triggered, such as from a distance that proximate to the car, such as about five feet, or to a somewhat greater distance, such as a couple of car lengths, or about thirty feet.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view of an infant seat for restraining an infant in an automobile vehicle;

FIG. 2 is an enlarged view of the RF transmitter incorporated into a chest latch;

FIG. 3 is an enlarged view of the portable RF receiver; and

FIG. 4 is a schematic of a GPS system in accord herewith;

FIG. 5 is a schematic of a system showing the signaling between an onboard receiver and a portable receiver from the transmitter; and

FIG. 6 is an exploded partial view of FIG. 5.

### DETAILED DESCRIPTION OF A PREFERRED EMBODIMENT

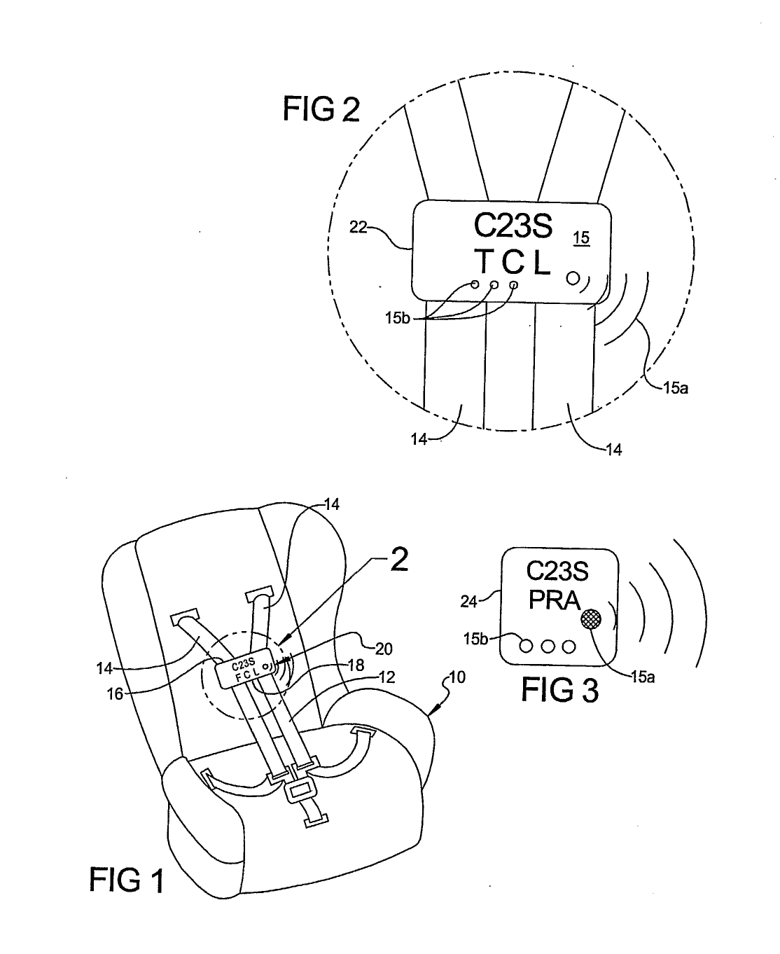

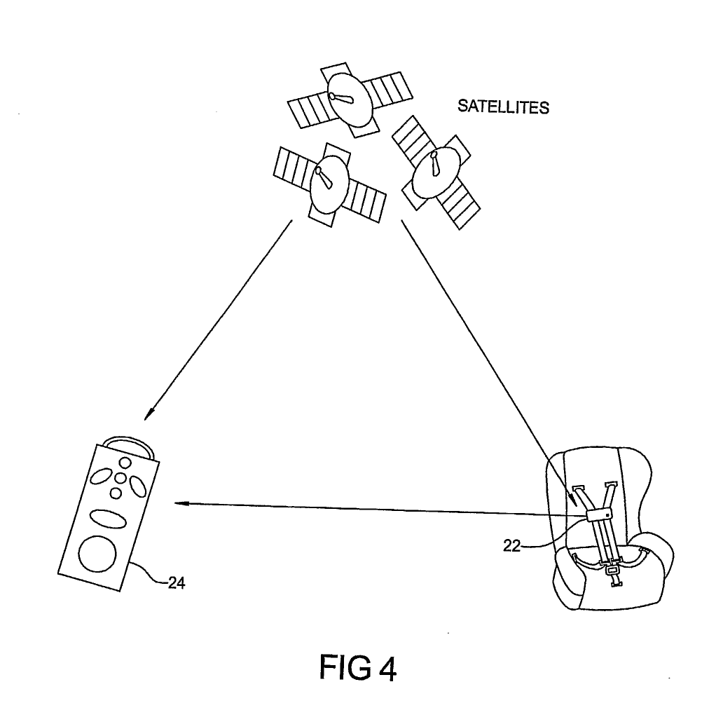

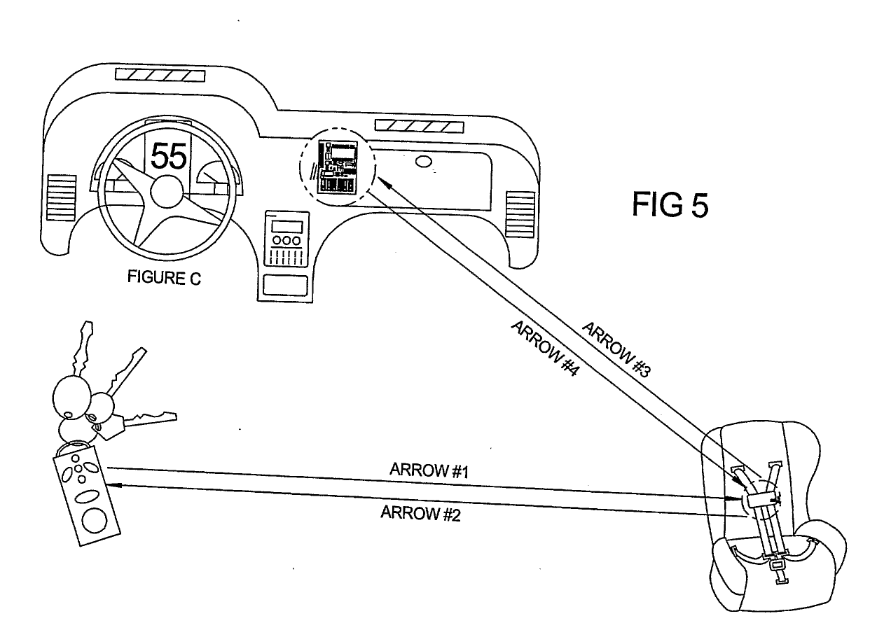

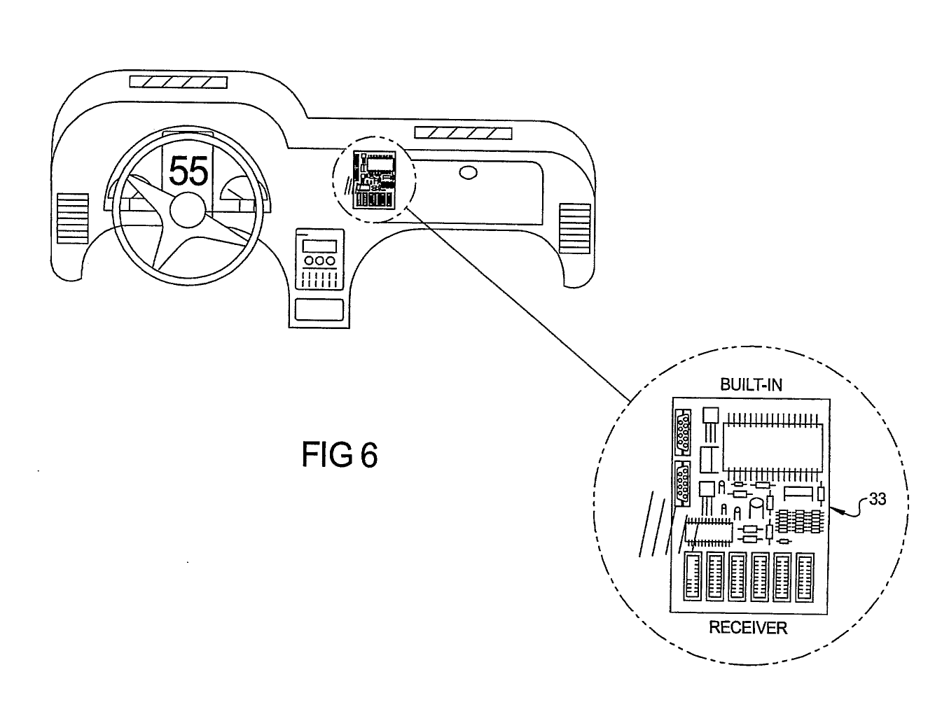

Turning now to the drawings, FIG. 1 illustrates an infant seat 10, adapted to be mounted on the rear seat of an automobile vehicle, restraint straps 12 and 14 which fit about and restrain a child or infant when in the seat, and seat buckles 16 and 18 which releasably interlock with one another to secure the child in the seat. While shown and discussed with particular reference to an automobile vehicle, the invention is not so limited.

According to this invention there is provided a warning system for warning or otherwise transmitting an alarm signal to a vehicle operator, leaving the vehicle, that a child has been left in the infant seat. The warning system, generally indicated by the number 20, includes an RF transmitter 22, and a portable RF receiver 24. The RF transmitter 22 is operably connected to the chest clip buckles 16 and 18 of the infant seat 10 and adapted to generate and transmit an RF signal of predetermined strength and frequency when the seat belt of the infant seat is buckled. The RF receiver 24 includes an alarm device and is adapted to receive the RF signal. The alarm device is operable to activate an alarm signal when the RF receiver exceeds a predetermined distance from the RF transmitter.

The RF transmitter 22 includes internal circuitry, such as in the form of an electrical circuit board, to transmit a signal of predetermined frequency and strength, and a power source, such as a small high power Lithium battery. Further, the electrical circuitry is placed in electrical circuit relation with the battery upon the seat buckles being interlocked and closed together.

In some arrangements, electrical wiring may extend through the restraint straps of the infant seat and complete an electrical path between the battery of the vehicle and the electrical circuitry.

The RF receiver 24 includes electronics and electrical circuitry that (a) compares the strength of the RF signal received from the RF transmitter with a reference value representative of the strength of the RF signal when the RF receiver is at the predetermined distance, and (b) generates an output when the RF receiver is at, or beyond, the predetermined distance. Further, the RF receiver 24 includes circuitry that connects the output to the alarm device, wherein to activate the alarm signal.

According to a preferred embodiment of the invention, the RF transmitter 22 and RF receiver 24 are adapted to transmit and receive RF signals that are coded.

When the RF receiver is carried by the vehicle operator, such as might be the child's parent, and the RF transmitter is in a transmitting mode by the interlocking of the belt buckles and/or chest clip buckles. In the transmitting mode, the RF transmitter continuously sends a signal to the RF receiver, whether constant and uniform in strength and/or value, or intermittently, wherein to save on battery drain. Preferably, the RF signal is adjustable (from a distance of one or two feet to perhaps as much as 30 feet. When the vehicle operator goes beyond the distance set by the vehicle operator, the RF receiver will begin to send out an alarm, such as in the form of a loud beeping sound, which may be continuous or intermittent.

Preferably, the RF transmitter 22 and RF receiver 24 include circuitry that automatically adjust as to frequency if more than one vehicle operator is in the area and using a child warning system of like frequency.

Optimally, the RF transmitter 22 includes circuitry for transmitting an off signal to the RF receiver 24 when the seat buckle and/or chest clip is unbuckled, and the RF receiver includes circuitry, operably coupled to the alarm device, for receiving the off signal whereby to turn the alarm signal off.

As illustrated in FIG. 3, an alarm may be in the form or one or more lights 24a being illuminated, or by a buzzing sound, indicated at 24b, or by vibrating. The sound level or buzzing noise may gradually increase in intensity, over time, to attract the attention of the busy but otherwise distracted parent. Additionally, the circuitry may preferably include a button operable to activate time delay circuitry, which when pushed, would disable the child alarm feature and place the alarm in a deactivated state for a predetermined time (e.g., 30 second to a minute). The deactivation could only be repeated for a predetermined number of times (e.g., two times).

While not shown, the receiver 24 may include a built in flashlight (e.g., such as in the form of an LED), or serve as a storage container for extra batteries, include a panic button.

As well, the receiver 24 may be combined with other electronic components.

While not intended to be limited, the chest clip could include MP3, radios, electronic games, just for fun games, receivers for on-board entertainment, a watch, a portable beeper, portable text messaging apparatus, portable computing devices, portable e-mail gadgets, cell phones, and GPS and like satellite enabled phones.

According to another embodiment of this invention, there is provided an alarm apparatus for indicating the presence of a child buckled in a child restraint seat and left unattended in a vehicle when the vehicle operator is remote to the vehicle. The alarm apparatus comprises a proximity transmitter capable of transmitting an RF signal of predetermined frequency and strength, and sonic transmissions of predetermined frequency and volume, and a proximity receiver capable of receiving RF signals and sonic signals transmitted from said transmitter. The proximity transmitter is coupled to the chest clip and activated upon buckling of the chest clip.

Further, the alarm apparatus includes a proximity range adjuster, that is coupled to the proximity receiver and is adapted to (a) compare the time taken for the RF signal from the RF transmitter to be received by the RF receiver with the time taken to receive a sonic signal with the acceptable difference representing a predetermined range, and (b) generate an alarm signal when the time taken to receive the RF sonic signal is not within the predetermined range. The time taken is representative of a maximum predetermined distance that the vehicle operator is permitted to be from the infant seat.

In an aspect of this latter embodiment, the predetermined range can be increased or decreased, depending upon whether the vehicle operator wishes to increase or decrease the distance the vehicle operator is permitted to be from the vehicle before an alarm signal is generated.

In another preferred embodiment, hereof and it is known to those skilled in the art to which the present invention pertains, a child's car seat, generally, denoted 10 includes a plurality of interconnecting or buckled straps 12 including chest straps 14. The straps are made from suitable webbing and buckles which are well known and commercially available. Any of such can be used herein.

In connection with the present invention, the transmitting device or transmitter 22 is secured to at least one of the chest straps 14 and, preferably, both by being mounted onto or integrated into a suitable base member 15 having a suitable interconnecting latching member associated therewith for encircling and being detachably latchingly secured about the chest straps 14. The transmitter 22 includes switching means associated therewith incorporated into the means for encircling such that upon the interconnection between one latch member to its opposing and receiving latch member that a circuit is completed enabling the transmitter 22 to actuate. The actual construction of the latching or buckling system is not critical hereto, only that it include suitable circuitry that closes upon the interconnection of the latch members to actuate the circuit for emitting a signal indicating a “latched state”. The chest clip could take the form of a one piece hooking format.

Furthermore, the actual circuitry for closing the switch is not critical hereto and may comprise any of that well know in the prior art. That is critical is that the circuitry be embedded into the transmitter and be covered by the latching members such that upon interconnection a signal is generated.

According to this embodiment, a receiver is disposed within the vehicle at any suitable location and receives the signal from the transmitter 22. The signal is, then, sent through suitable electronic connection to the on-board computer and/or other electronic system of the vehicle, either one or both of which monitor the output from the receiver or the on-board computer system which relays the signal to such other vehicle electronic system. Once the computer or other electronics senses a “door open” condition, or a hazardous situation, while still receiving the output from the receiver, an audible or other signal, e.g. flashing lights, etc., is generated through suitable means signaling the latched status of the transmitting member, thus, cautioning the driver or other occupant of the vehicle that a child is still strapped into the seat while actuating other vehicle operations, e.g. activating the air conditioning systems, opening the windows, generating phone calls, etc., if necessary.

The actual coding of the computer (including the requisite software), receiver and transmitting devices, again, is well known to those skilled in the art such as is found in garage door opener transmitters and cell phones and so forth.

It is to be appreciated that the present invention as been described in terms of a RF and sonic transmitter and receiver but certainly anyone skilled in the art of will appreciate that IR, sonic, photo-optic and similar technologies could also be used.

It is further to be appreciated that the present invention can comprise a GPS system of a transmitter and receiver where continuous signals are sent from a plurality of satellites and the receiver enables the reception of the signal. More specifically, according to this embodiment, the receiver 24 receives signals from the GPS satellites to locate the receiver. The satellites, at the same time, send to the transmitter 22 the transmitter locating information, which is, then, relayed to the receiver 24. Using the standard GPS triangulation calculation, the location of the chest clip is determined by the receiver in relation to it. If the distance is too great, then, an alarm is activated by the receiver.

Alternately, it is to be readily appreciated that the transmitter itself can be in a continuous “on” state with no need for circuitry being incorporated into the latching system.

It is further contemplated that the present invention would have its own battery pack or cell battery associated therewith and built into the housing of the transmitter.

Further, the child alert and/or alarm system would include circuitry that would enable the operator to perform a self test and/or check of the system and confirm that the system is operating. This testing circuitry would enable the operator to send and receive signals between the RF transmitter and RF receiver and confirm that the system works, and prior to leaving the vehicle and the child in the infant seat, as well as check the battery strength.

The alarm system for use in an infant restraint seat, as described above, has many advantages. First, the system is simple, inexpensive, and capable of being provided as original equipment with currently manufactured vehicles or retrofitted on older cars. This enables the operators of all vehicles to have available an unattended child safety feature.

Second, the alarm is automatic and prevents the operator from an inattentive forgetting and leaving a child unattended in the car. The warning system automatically activates when the seat belt system locks about the child.

The wireless warning can be modified by the user to increase or shorten the distance between the portable receiver and transmitter before the alarm signal is generated. For example, the alarm may be triggered when the user is almost next to the exit door of the car, such as about five feet, or from to a somewhat greater distance, such as a couple of car lengths, or about twenty to thirty feet.

The alarm system can be removed and reassembled on an infant seat to permit cleaning of the seat. Further by the transmitter being integrated with the seat buckle system of the car seat, the transmitter is hidden from abuse and/or inadvertent use by the child.

The receiver may be conveniently carried on the key ring of the vehicle operator, and even be integrated into the wireless “fob” used by the vehicle operator to gain access to the vehicle. Should there be a catastrophic failure of the vehicle power, and thus the operability of the on-board vehicle computer, the portable RF receiver 24 will still be operable.

Additionally, the wireless RF system may advantageously be powered by separately replaceable batteries or, at least in part, by wiring extending through the fastening system of the restraint wherein to be in electrical circuit relation with the battery of the vehicle.

Additionally, while described in the context of male and female seat buckles being interlocked, the activation may be from a chest clip being latched, fastened, clamped, hooked, or otherwise fastened. The signal may be RF or ultrasonic.

The alarm signal is coded for security reasons to permit communication with desired systems, but prevent false signals, such as from garage door openers and adjacent car seats, from triggering the alarm signal, or possessors of black market copies from gaining unauthorized access to the unattended child.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

I claim:

1. A warning system for warning a vehicle operator of the presence of a child buckled into an infant seat of the vehicle, the warning system comprising:
a transmitter, said transmitter being connected to a seat buckle of said infant seat and adapted to generate and transmit signal of predetermined strength and frequency when the seat belt of the infant seat is buckled, and
a receiver unit, said receiver unit including an alarm device and adapted to receive said signal,
said alarm device being operable to activate an alarm signal when the RF receiver exceeds a predetermined distance from the RF transmitter when said child restraint is closed about the child and the vehicle operator provided with the receiver is remote to the vehicle by a distance greater than that permitted by the reference value, the alarm signal is transmitted to the alarm device and the vehicle operator is warned.

2. The warning system of claim 1, further wherein said RF receiver unit includes an electrical circuit in operable relation with said alarm device, said electrical circuit including:
means for comparing the strength of the RF signal received from the transmitter with a reference value representative of the strength of said RF signal when said receiver unit is at said predetermined distance and generating an output when the receiver unit is at said predetermined distance, and
means for connecting the output to the alarm device, wherein to activate said alarm signal.

3. The warning system of claim 2, wherein the means for comparing utilizes a satellite based Global Positioning System GPS).

4. The warning system of claim 1, wherein the alarm signal has a predetermined intensity, and further including means for amplifying the intensity of the alarm signal.

5. The warning system of claim 4, wherein the means for amplifying produces an audio signal of increased intensity.

6. The warning system of claim 4, wherein the means for amplifying causes the receiver to vibrate.

7. The warning system of claim 1, wherein the receiver is incorporated into an auxiliary system.

8. The warning system of claim 7, wherein the auxiliary system is a cell phone, watch, e-mail transmitter, text messager, electronic pager, satellite phone, and computing device.

9. The warning system of claim 1, further wherein said RF receiver unit includes means for disabling the alarm signal for a predetermined period.

10. An apparatus for warning a vehicle operator having left the vehicle that a child has been left unattended in a car seat of the vehicle, the apparatus comprising:
a seat belt for restraining the child in the seat, said seat belt including a seat belt buckle structure for releasably locking the seat belt restraint about the child,
means for detecting that the buckle structure is locked, indicative of the fact that a child is buckled into a car seat,
transmitting means for transmitting an RF signal of predetermined frequency when the seat buckle of the child seat is buckled, said transmitting means connected to said detector means,
portable receiving means for receiving an RF signal of predetermined strength, the receiving means being operably connected to an alarm device having an alarm signal, the receiving means activating the alarm signal to alert said vehicle operator when the strength of said RF signal falls below a permitted value.

11. The apparatus of claim 10, wherein said transmitting means is operably associated with the seat belt buckle of the car seat and is activated upon interengagement of the seat belt buckle about the child when said child restraint is closed about the child and the vehicle operator provided with the receiver is remote to the vehicle by a distance greater than that permitted by the reference value, the alarm signal is transmitted to the alarm device and the vehicle operator is warned.

12. The apparatus of claim 10, wherein the permitted value is adjustable and representative of a permitted proximity that said receiving means may be from said transmitting means.

13. The apparatus of claim 10, wherein said receiver and transmitter are in operable relation with the Global positioning system to determine the location of both said transmitter and receiver, and further comprising
means for transmitting RF signals representative of the locations of the transmitter and receiver between said transmitter and receiver,
means for comparing the locations in order to determine whether the determined locations exceed a predetermined distance, and
means for sounding an alarm if the predetermined distance is exceeded.

14. The apparatus of claim 10, wherein
said transmitting means further includes means for transmitting an off signal to said receiving means when said belt buckle is unbuckled, and
said receiving means includes a receiver adapted to receive said off signal and turn off the alarm signal.

15. The apparatus of claim 10, wherein said transmitting means and said receiving means each include separate power sources and each, respectively, are adapted to transmit and receive RF signals that are coded.

16. An alarm apparatus for indicating the presence of a child buckled in a child restraint seat and left unattended in a vehicle when the vehicle operator is remote to the vehicle, the alarm apparatus comprising:
a proximity transmitter capable of transmitting an RF signal of predetermined frequency and strength, said transmitter being coupled to the seat belt and activated upon buckling of the seat belt,
a proximity receiver capable of receiving RF signals transmitted from said proximity transmitter,
a proximity range adjuster coupled to said receiver for comparing the time taken for an RF signal from the RF proximity transmitter to be received by the RF proximity receiver with a predetermined range and generating an alarm signal when the time taken is not within the predetermined range, the time taken being representative of a maximum predetermined distance that the vehicle operator is permitted to be from the infant seat.

17. The alarm apparatus of claim 16, wherein the predetermined range can be increased or decreased, depending upon whether the vehicle operator wishes to increase or decrease the distance the vehicle operator is permitted to be from the vehicle before an alarm signal is generated.

18. The alarm apparatus of claim 16, wherein the proximity range adjuster includes an on-board vehicle computer, the computer being in communication with the Global Positioning System and adapted to send and receive the RF signal between the proximity receiver and the proximity transmitter.

19. The alarm apparatus of claim 16, wherein the RF signals transmitted from said proximity transmitter are coded.

20. The alarm apparatus of claim 16, further wherein:
said proximity transmitter is also capable of transmitting a sonic signal of predetermined frequency and volume, said transmitter being coupled to the seat belt and activated upon buckling of the seat belt,
said proximity receiver is also capable of receiving sonic signals transmitted from said proximity transmitter, and
said proximity range adjuster is adapted to compare the time taken for a sonic signal and RF signal simultaneously transmitted from the proximity transmitter to be received by the proximity receiver with a predetermined range and generating an alarm signal when the differences between the time taken to be received is not within the predetermined range, the time taken being representative of a maximum predetermined distance that the vehicle operator is permitted to be from the infant seat.

21. A vehicular warning system for signaling the presence of a child buckled into an infant seat of a vehicle, comprising:
a transmitter, the transmitter being connected to a seat buckle of the infant seat and adapted to generate and transmit a signal of predetermined strength and frequency when the seat belt of the infant seat is buckled,
a receiver unit comprising at least a vehicular mounted receiver in electronic communication with at least a vehicle on-board computer, the receiver emitting a signal to indicate the buckled status of the seat belt,
the on-board computer adapted to activate a requisite vehicular operation responsive to a sensed condition within the vehicle when the receiver is sensing the buckled state of the seat belt; and
the receiver emitting an audio or visual signal to indicate the buckled state of the infant seat.
